(19) United States
(12) Patent Application Publication
(10) Pub. No.: US 2007/0255818 A1
(43) Pub. Date: Nov. 1, 2007

(54) Method of detecting unauthorized access to a system or an electronic device

(75) Inventors: Terry Owen Tanzer, Glen Cove, NY (US); Nicholas P. Gianakas, Bayport, NY (US)

Correspondence Address: RICHARD W. TANZER, 413 BEAULIEU RD, NEENAH, WI, 54956, US

(73) Assignee: Kolnos Systems, Inc., Glen Cove, NY (US)

(21) Appl. No.: 11/380,921

(22) Filed: Apr. 29, 2006

(51) Int. Cl. G06F 15/173

(52) U.S. Cl. 709/224

(57) ABSTRACT

Characteristics of a user's behavior on an electronic device are captured and stored. These stored characteristics are compared to the characteristics of a subsequent user purporting to be the same person. If the differences in the characteristics are such that fraud is suspected, an alert is activated.

### CROSS REFERENCE TO RELATED APPLICATIONS

Not Applicable

### BACKGROUND OF THE INVENTION

In U.S. Pat. No. 6,112,240, Pogue, et al.; Aug. 29, 2000, “utilizes a tracker tag in the code of the web page for initiating a client information tracking program.” The tracker tag records inter-page client activity including the number of times a page is downloaded by the browser.

At MIT Media Lab, Lockerd, A. & Mueller, F. detail a project in Cheese: Tracking Mouse Movements on Web sites, A Tool for User Modeling, (2001) CHI2001, where mouse tracking data is captured and stored on a server. The stored mouse tracking data are aggregated and the mouse navigation paths presented as an overlay over the web page that was tracked.

At Clemson University, in the Advanced Reading Technology Group, Applied Psychology, Andy Edmonds in his IRB Exempt MS Thesis Work, entitled Visualizing Menu Mousing, April, 2004, captures mouse navigation including mouse speed and presents the paths as transparencies over the web page being tracked.

The Wells Fargo Bank has the capability of sending alerts to an email address provided by the customer when there are several successive unsuccessful attempts to login to a web site application as a particular customer. See Wells Fargo Offers Free Alerts by Ivan Schneider in Bank Systems & Technology, Aug. 2, 2005.

In U.S. Pat. No. 5,224,173, Kuhns; Roger J, et. al.; Jun. 29, 1993, a process to compare signatures is described as follows, “A current applicant for a government benefit presents a fingerprint signature to a large data bank to determine if his signature is already in the data bank, to thus indicate fraud. His fingerprint is rapidly machine correlated with the fingerprints of prior approved applicants and a number of close matches are thereafter visually examined by a human operator to definitively determine whether the current applicant's fingerprint is already in the data bank.” An actual human signature is used for comparison and to reduce the number of possible matches and then relies on human comparisons for the final comparisons.

On Nov. 18, 2003, in an online forum http://www.halfbakery.com/idea/mouse_{—}20movement_{—}20analyser, a user identified as “sporn”, wrote “Write a neural net type program to analyze mouse movements, much like hand writing. You could sit down and trace out your signature with the mouse pointer and it would recognize you and log you in—no more passwords to remember. No new hardware to buy and almost impossible to fake.”

This idea was implemented by Everitt R. & McOwan P. W. as detailed in their article Java-Based Internet Biometric Authentication System, IEEE Transactions on Pattern Analysis and Machine Intelligence 25, No 9, September 2003 pp 1166-1172. See: http://www.dcs.qmul.ac.uk/˜pmco/Biometricdemo.htm

In U.S. Pat. No. 6,687,390 (Avni, et al., Feb. 3, 2004), a method of capturing a user human signature made with a pointing device (or a mouse) on a background graphic image is referred to as a “Virtual Pad.” The user must follow a prescribed series of pointer movements within a defined area. Avani discloses “Using the pointer or pointing device (hereinafter, ‘PD’), the user draws lines and drags (repositions) and/or clicks on icons positioned on a background image to create a user PD signature.” Avani also provides a biometric authentication to permit a user to gain access or entry to a secure application, site or function; and also provides an initial authentication of users in lieu of a user ID and password and therefore must be able to distinguish one user from another with a high degree of certainty.

In U.S. Pat. No. 6,769,066 (Betros, et al., Jul. 27, 2004) a process to detect network intrusion is disclosed which provides “ . . . computer network intrusion detection. In one aspect of the present invention, a method of artificially creating anomalous data for creating an artificial set of features reflecting anomalous behavior for a particular activity is described. A feature is selected from a features list. Normal-feature values associated with the feature are retrieved. A distribution of users of normal feature values and an expected distribution of users of anomalous feature values are then defined. Anomalous-behavior feature values are then produced. Advantageously, a network intrusion detection system can use a neural-network model that utilizes the artificially created anomalous-behavior feature values to detect potential intrusions into the computer network.”

In U.S. Pat. No. 6,769,066 (Botros, et al.) “a method of artificially creating anomalous data for creating an artificial set of features reflecting anomalous behavior for a particular activity is described . . . . Normal-feature values associated with the feature are retrieved. A distribution of users of normal feature values and an expected distribution of users of anomalous feature values are then defined. Anomalous-behavior feature values are then produced. Advantageously, a network intrusion detection system can use a neural-network model that utilizes the artificially created anomalous-behavior feature values to detect potential intrusions into the computer network.”

D. Denning, “An Intrusion Detection Model,” Proc 1986 IEEE Symp. Security & Privacy, (April 1986) provides an anomaly detection model (hereinafter the “Denning Model”) for detecting intrusions into computer systems. The Denning Model uses statistical profiles for user, dataset, and program usage to detect “exceptional” use of the system. There are variations of the Denning Model of anomaly detection models and different applications of these models. Anomaly detection techniques such as those based on the Denning Model, however, have generally proven to be ineffective and inefficient. Anomaly detection techniques, for instance, do not detect most actual misuses. The assumption that computer misuses would appear statistically anomalous has been proven false. When scripts of known attacks and misuses are replayed on computers with statistical anomaly detection systems, few if any of the scripts are identified as anomalous. This occurs because the small number of commands in these scripts is insufficient to violate profiling models.

U.S. Pat. No. 5,557,742 (Shama, et al., Sep. 17, 1996) reports that “Anomaly detection looks for statistically anomalous behavior. It assumes that intrusions and other security problems are rare and that they appear unusual when compared to other user behavior”. The patent presents an intrusion detection process based upon “misuse” of a processing system. Misuse is defined in U.S. Pat. No. 5,557,742, as “ . . . any act that a processing system manager or other party responsible for the processing system deems unacceptable and undesirable and includes known attack outcomes, attempts to exploit known system vulnerabilities, and typical outcomes of system attacks.”

In U.S. Pat. No. 6,792,546 (Shanklin, et al., issued Sep. 14, 2004) an “Intrusion detection signature analysis using regular expressions and logical operators” is described. '546 provides the following definition: “A “signature event” can be a packet type, a sequence of packet types, or any one of a number of signature-related events, such as a count or a time period. Logical operators are used to describe relationships between the signature events, such as whether a count exceeds a certain value. For each signature, one or more of these identifiers and operators are combined to provide a regular expression describing that signature.

The instant invention addresses limitations of earlier computer security systems.

The present system and method provides enhanced security in a manner that is transparent to the user, requires little if any new hardware, and does not significantly degrade the quality or response time of the user interface.

### BRIEF SUMMARY OF THE INVENTION

The present invention relates to capturing user attributes on a system or electronic device and comparing the attributes to corresponding attributes from previously-recorded data from the user.

It is an object of the present invention to provide a process to capture a user's behavior, store the captured information and create a signature that will uniquely reflect the user's behavior. The same procedure is performed for at least one of the user's subsequent sessions with the system. When a user's behaviors suggest unauthorized access, the process can respond in a custom-defined manner. As an example in the case of a local electronic device, the process can lock the impostor out of the device or prevent the impostor from accessing certain functionality on the device. As an example in the case of a networked deployment, the process can alert the actual customer or a responsible party, and/or require the user to provide additional authentication or proof of identity.

### BRIEF DESCRIPTION OF DIAGRAMS

The objects, features, and advantages of various aspects of the present invention are illustrated in the accompanying drawing and flow charts in which like reference characters refer to the same components throughout the different views. A networked embodiment of the invention is described. One aspect in which a networked embodiment differs from the stand alone or other electronic device embodiments is that in a network different functions can be performed on different machines. Local device embodiments of the invention are generally similar to networked embodiments of the invention; however, some data attributes are available in networked systems but not local systems and vice versa.

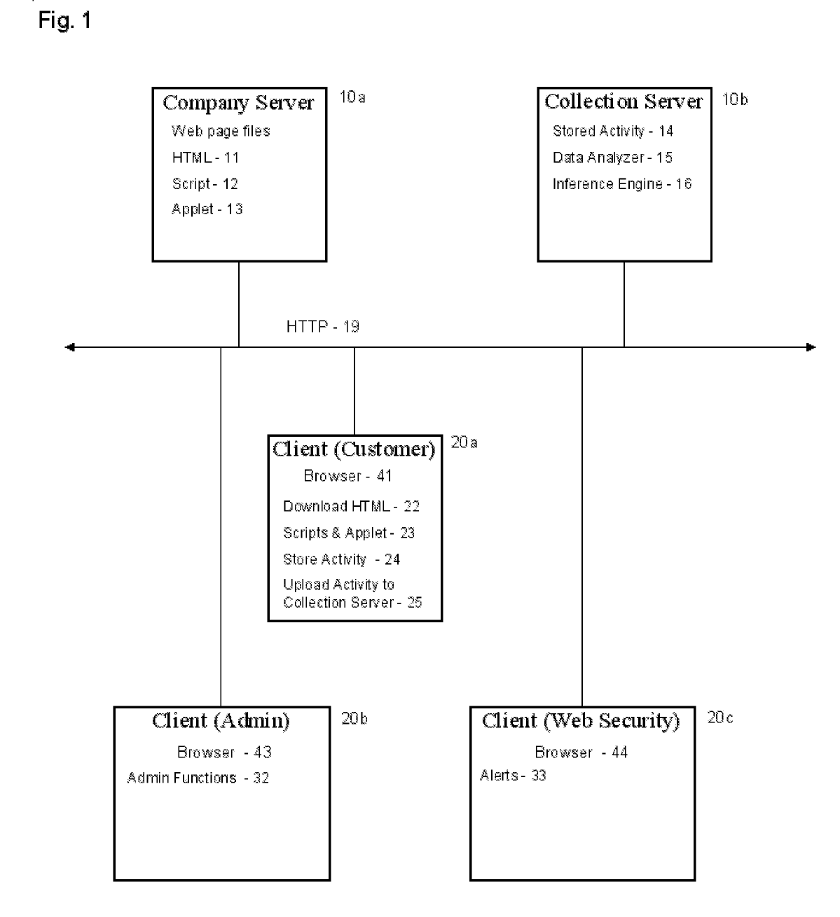

FIG. 1 is a block diagram of a client-server computing system illustrating components of various embodiments of the present invention in one environment. The accompanying text describes the role of each component.

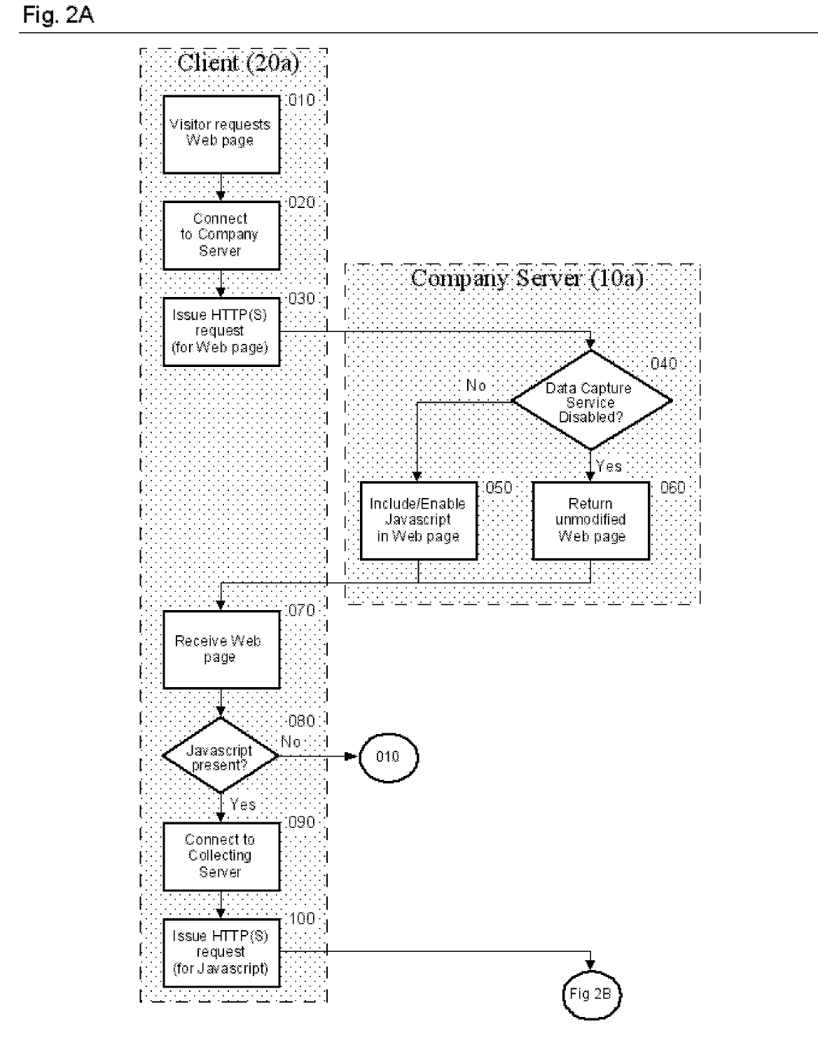

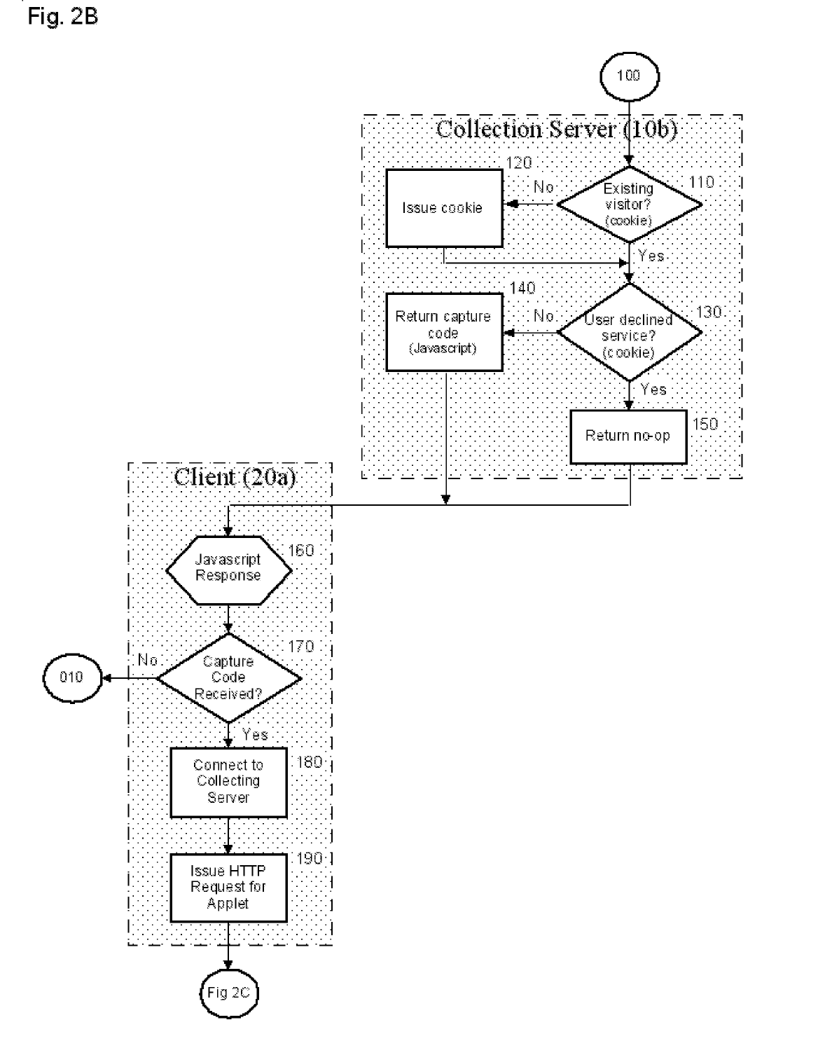

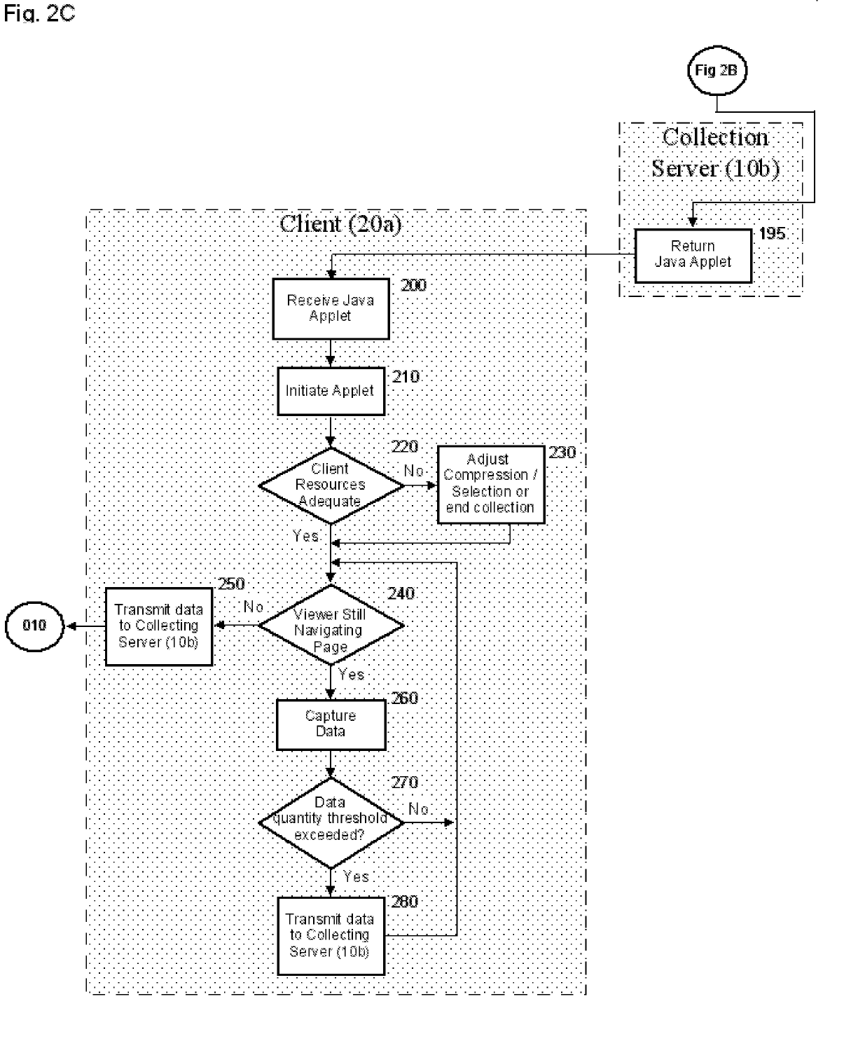

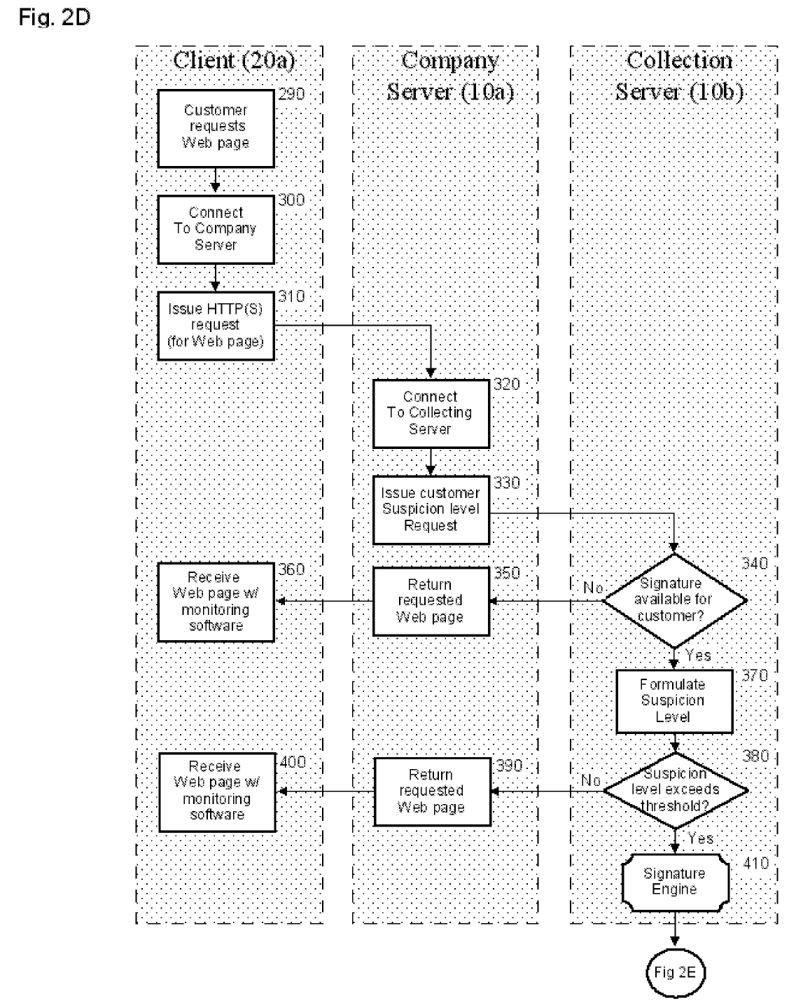

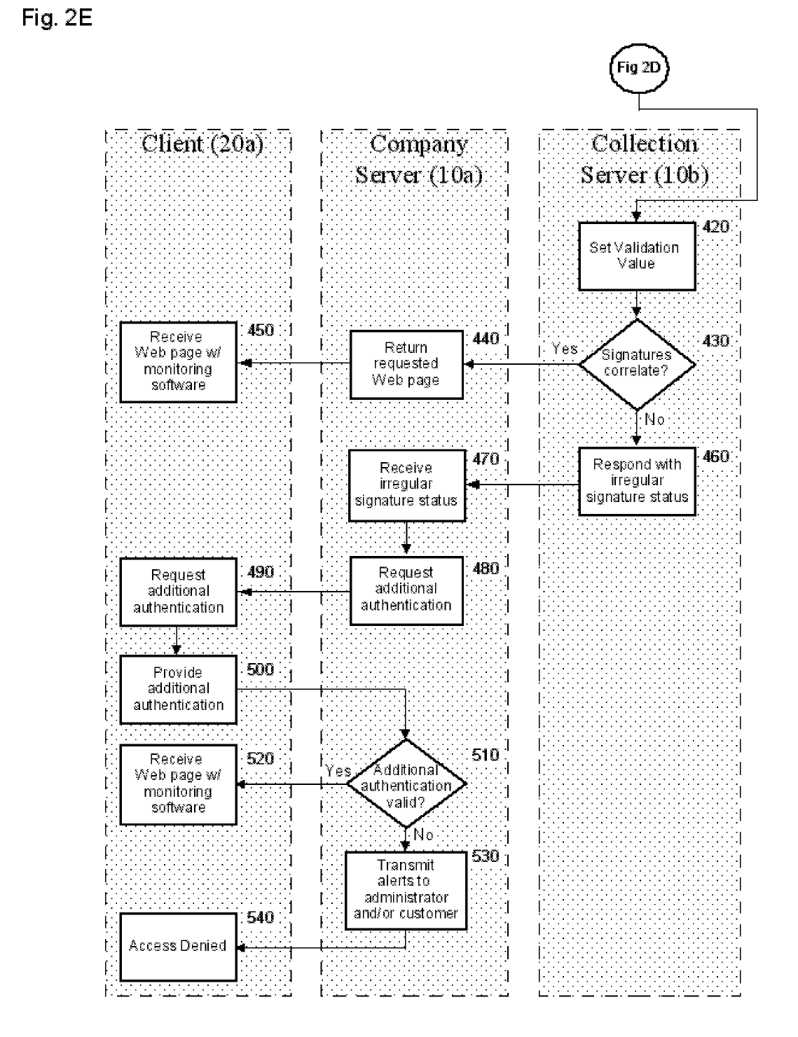

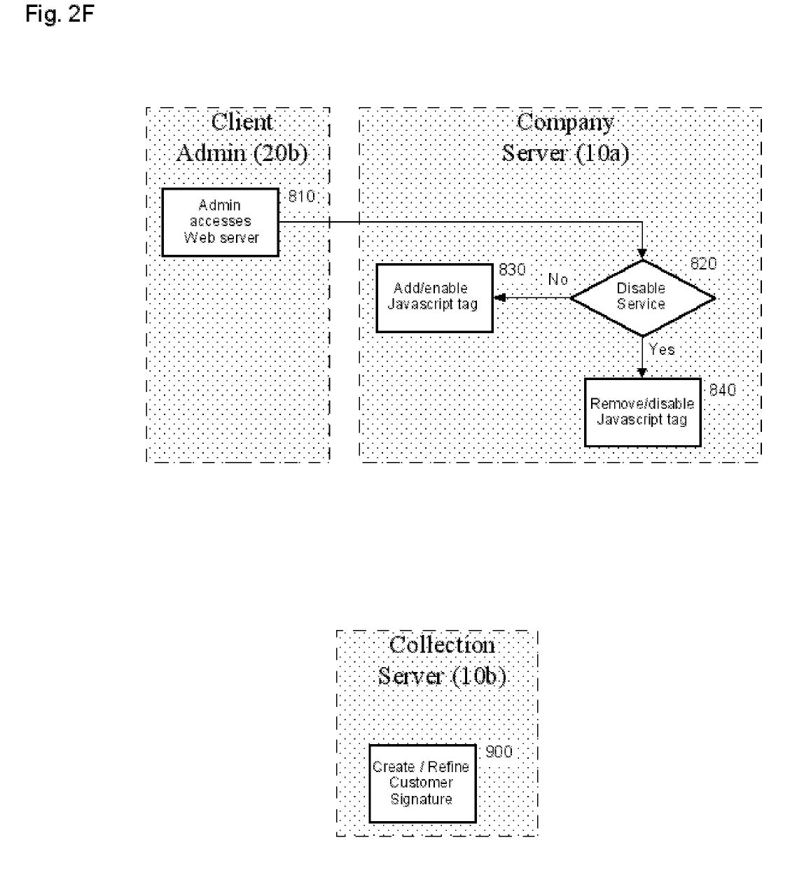

FIG. 2A through FIG. 2F are flow charts that detail the functions of the present invention as it relates to the collection of client attributes, analysis of the client attributes, the detection of possible unauthorized access and the transmission of warnings. On a network these functions will be performed on servers referred to as the Company and Collecting Server and on clients referred to as the Customer Client, Administrator and Web Security Client. The Company Server contains the web page and related files that are of interest to the customer who accesses the web page through their computers or other electronic devices which are known as clients. Each client's attributes are captured on their local machine and then uploaded to a server designated as the Collection Server. The details are described in the flow charts entitled FIG. 2A, through FIG. 2F, along with the accompanying write-up below.

### DETAILED DESCRIPTION OF THE INVENTION

In one networked embodiment of the present invention, which in this case is Web based, the process makes use of client-side scripting, JavaScript™ (JavaScript is a trademark of Sun Microsystems Corporation of Sunnyvale, Calif.) is embedded into an HTML document or references an HTML document and, is executed by the user's Web client browser, such as Netscape™ (Netscape™ is a trademark of Netscape Communications Corporation), Opera™ (Opera™ is a trademark of Opera Software AS), or Internet Explorer™ (Internet Explorer™ is a trademark of Microsoft Corp.). The JavaScript™ captures the user activity, buffers the data, and feeds the data to an Applet. The Applet, Java™ (Java™ is a trademark of Sun Microsystems Corporation of Sunnyvale, Calif.) in the networked embodiment, performs a number of operations and transmits the captured data to a data collecting server. Some of the operations that the Applet performs can include reducing the volume of data transmitted to the collecting server, providing data security, determining the user's behaviors, and modifying the procedure to minimize delays.

In a networked embodiment, when behavior data are captured, they are transmitted to the collecting server for storage and analysis. If the user accesses a resource that requires authorization, the user-identifiable information is stored along with the behavior data on the collecting server. In this context “user-identifiable information” includes a customer-supplied derivative, or correlation to the ID such as through the use of a hash function. Some of the behavior data collected help to establish the usual place and equipment the user uses to access the resource, i.e. when and where the user accesses the network.

A specific type of analysis is performed on the behavior data collected. The analysis is performed to create a signature for each ID after a number of sessions have been captured for a particular user. The signature is developed by examining certain key elements of the user's behavior. Examples include input device dither (slight variations in the path when moving from one point to another on the screen), relative navigation speeds, length of navigation pauses, resource access patterns, key stroke rate and rhythm, use of various combination key strokes, use of pull down menus, log-on and log-off times. Another example of a key element of a user's behavior is the tendency for individuals to “click” the mouse over certain portions of labeled icons or buttons; some persons routinely click on the written word, while other persons routinely click on the icon or button. These behaviors are measured and recorded as behavior data.

The behavior data are converted to statistically useful values. For example, a user's dither in mouse movement can conveniently be converted to a dimensionless scale ranging from 0 to 1, where 0 represents completely random movement over some time scale and 1 represents straight-line movement. In a second example, resource access patterns can be converted to a scale from just above 0 to 1 by determining the fraction of time that a user accesses their most frequently accessed web page, compared to the total time that the user accesses web pages. As an example of this method of quantifying resource access patterns, a user working in the Purchasing Unit may most frequently access the Purchasing Unit home page; 7% of the time that user is accessing web pages the Purchasing Unit home page is active on their computer. So this index of resource access patterns would equal 0.07.

The signature can be developed from a single session; this can be expressed as: Si=f{w1·b1, w2·b2, w3·b3, . . . } wherein Si is the signature for an individual session, and b1, b2, and b3 are statistically useful values representing behaviors or attributes 1, 2, and 3. w1, w2, and w3 represent relative weights for each behavior. Various behaviors or attributes can be given greater or lesser weight in the creation of a signature. For example, behavior or attribute 1 can be a more important factor than behaviors or attributes 2, or 3 in evaluating the identity of the user; in this situation w1 can be assigned a larger value than w2 or w3. In this sense, Si is a relative weight-biased signature. Alternatively, w1, w2, w3 . . . may all have the same magnitude, in such a situation Si is unbiased.

The difference between two signatures, Si−j, can be calculated in various ways. One method is to evaluate each signature as a scalar quantity; in that situation Si−j=Si−Sj, a simple arithmetic subtraction. Alternatively, Si and Sj can represent vector or matrix functions; in that situation Si−j can be calculated by evaluating each biased or unbiased behavior or attribute datum, and generating a difference vector or matrix, which can be converted into a scalar quantity.

In the context of evaluating the “difference” between two signatures, a difference can be a more complex function than a simple subtraction. Various ratios and statistical analyses are included in the term “difference,” the objective of the difference evaluation being to determine if a first signature is suspiciously too different (or suspiciously too similar) from a second signature.

A signature can be developed for a single session, and more generally, a signature is developed over the course of several user sessions. Signatures developed from two, three, four or more sessions can be useful.

It has been demonstrated that certain behaviors tend to be consistent for an individual and are effective in distinguishing one user from another.

To determine if the current user is different from the user who used the system in a prior session, an historical signature is compared with the current signature. When the comparison of signatures is done, significant differences in the signatures suggest different individuals are using the same authentication credentials, indicating a possible fraud situation. The magnitude of difference between the historical signature and the current signature is compared to a validation threshold. The validation threshold is set at a value that suggests a fraud situation exists. Typically the validation threshold is established a priori, but it can be generated dynamically.

The validation threshold can represent a maximum acceptable level for the difference between the historical signature and the current signature. When used in this manner, the validation threshold is used to identify differences between signatures that have changed to such an extent that fraud is suggested.

Alternatively, the validation threshold can represent a minimum acceptable level for the difference between the historical signature and the current signature. When used in this manner, the validation threshold is used to identify differences between signatures that are so minor as to suggest that a fraud involving copying of behaviors is taking place.

The validation threshold may be set to have high sensitivity, so that even minor signature variability is identified as declaring a possible security breach. A very sensitive validation threshold has the advantage of identifying virtually all security breaches, but has the disadvantage of triggering many false alarms. Conversely the validation threshold may be set to have low sensitivity, so that only substantial signature variability is identified as declaring a possible security breach. An insensitive validation threshold has the disadvantage of missing identifying some security breaches, but has the advantage of triggering few false alarms.

In some embodiments of the invention the detection program operates in a two-tier mode. An initial comparison, i.e. prescreening, between a subset of behaviors in the user's current session with the same subset of behaviors in the historical data. If the difference between the current behavior subset and the historic behavior subset exhibited by the same user exceeds a threshold level, referred to as the suspicion threshold, a current user session signature is created and a current versus historic signature comparison is performed. The suspicion analysis is a prescreening mechanism that determines whether a user will participate in the signature creation and comparison. Any attribute or combination of attributes available can constitute the subset and be examined to determine the suspicion level. Analysis of a subset of behaviors, relative to creating and comparing full signatures, reduces the load on system resources.

The effect each attribute has on the overall analysis may not be the same as another attribute. As an example, in an office setting where all workers only work traditional office hours, a log-on time of 2 AM on Sunday is noteworthy. In many office and industrial environments however, a 2 AM Sunday log-in time is of no particular interest or concern; and log-in time might be given little weight when calculating a suspicion level.

Definitions

“Administrator” and its derivatives refer to the person or persons who maintain the web site which contains the web page being monitored and have responsibility for the performance of the web site.

“Attribute” and its derivatives refer to behaviors plus detectable hardware and software characteristics of the user's electronic device, and user linkages. For networked embodiments, inter-page navigation patterns and many values commonly captured on web logs are considered attributes. Some other attributes include: application functions utilized, hardware characteristics including CPU and memory, operating system and version, browser type, browser version, latency, bandwidth of network connection, geographical location, IP address, date and time. A user's attributes are those attributes associated with the electronic device utilized by the user and his or her behaviors.

“Behavior” and its derivatives refer to the interactions performed by a user on individual screens or intra-page in a networked environment and include pointer or mouse navigation, pointer or mouse speed, direction, pauses and acceleration, button actions, keyboard entry and the association between the navigation and objects on the page or screen. Other examples of user “behavior” are accessing certain programs, accessing certain web pages, and the use of pull down menus versus the use of icons or keyboard short cuts to control functions of an electronic device.

“Collecting server” and its derivatives refer to a computer or computers, on which programs run, that provides the service of collecting and aggregating and storing data that was transmitted from the client computer.

“Customer” and its derivatives refer to any visitor to a web page. The word customer is used because frequently the visitor has conducted or potentially will conduct business or view sensitive or private information on the web site.

“Inter-page” and its derivatives refer to the actions that take place between pages, such as linking from one page to another within a web site.

“Intra-page” and its derivatives refer to actions that take place within a single web page, such as moving the mouse from one point to another on a web page.

“Navigation” and its derivatives refer to the path taken by a mouse on a web page, including the mouse direction and speed, the duration of mouse pauses (the length of time and the location of the mouse when it is not moving) and when the buttons on the mouse are depressed or raised (button clicks on the mouse).

“Networked (client/server) environment” and its derivatives refer to an architecture or system design that divides processing between client computers and servers that usually run on different machines on the same network. The client computer requests data from the server. The client then presents the data to the user via some interface. Presentation can be made via a graphical user interface (GUI). The server maintains the data and processes requests for said data to clients possibly on a selective basis. A web server, for example, stores files related to web sites and serves (i.e., sends) them across the Internet to clients (i.e., web browsers) when requested.

“Session” and its derivatives refer to the period from when a user enters a web page being monitored and ends when the user leaves the web page (implicitly or explicitly), In a networked (or client/server) environment. When a client leaves a page and later returns to the same page a new client session is initiated. On a stand alone machine a session begins when the user logs into the machine and ends when the user logs off the machine.

“Signature” and its derivatives refer to a record of distinguishable characteristics based upon a user's behavior that serves to distinguish one individual from another. The term “signature” is distinguished from the term “human signature” which is defined as a person's hand inscription of their own name.

“Suspicion level” and its derivatives refer to a relative score based upon user attributes.

“Suspicion Threshold” and its derivatives refer to a predetermined value against which a difference between suspicion levels is evaluated.

“User” and its derivatives refer to any person using an electronic device, such as a computer.

“Web site owner” and its derivatives refer to the enterprise that is presenting information and/or is conducting e-business on the web site. For financial institutions and retail outlets the web site has underlying applications to process customer data.

Generally computer systems require some form of authentication to obtain access, such as an identification number (ID) and password. In some embodiments of the invention, data from a user's behavior are captured, stored, aggregated, and analyzed to generate a user signature. These functions can be conducted in place of, or in addition to the ID/password authentication process. After collecting some minimum number of data sets from a particular user, where each set corresponds to all of that user's behavior data from a single session, the records containing the user behavior are used to generate a unique signature for the user. The signature is developed from at least one, alternatively at least two, optionally at least three, or at least four sessions by the user of system. The data from each subsequent session by the same user can be collected, stored, aggregated, analyzed and compared to the user's signature on file.

A substantial change in characteristics of the most recent session compared to the stored signature, i.e. an historical signature, for the user will yield inconsistent signatures, suggesting that an unauthorized person is using the system (identity fraud). Persons interacting with the system who claim to be the same user, by using the same log-on or identification data, are referred to as the same “purported user”. Generally, persons who are the same purported user are indeed the same actual user. However in the case of fraud, there is at least a first user and a second user purporting to be the same user, but in fact the first user and second users are different persons. One way to define “identity fraud” is the situation in which two users who are purportedly the same user are in fact different users.

The validation threshold can represent a maximum acceptable level for the difference between the historical signature and the current signature. When used in this manner, the validation threshold is used to identify differences between signatures that have changed to such an extent that fraud is suggested. Alternatively, the validation threshold can represent a minimum acceptable level for the difference between the historical signature and the current signature. When used in this manner, the validation threshold is used to identify differences between signatures that are so insubstantial as to suggest that a fraud involving copying of behaviors is taking place. When the difference between the historical signature and the current signature exceeds maximum validation threshold, or when the difference between the historical signature and the current signature is less than a minimum validation threshold, unauthorized access is indicated and the process can declare a possible security breach and take appropriate security actions.

The security action(s) taken are completely customizable to accommodate various deployments of the process. Probably the most common examples of security actions is downloading another Web page to the user to request additional identifying information. Other examples of security actions include restricting or shutting down system access to the user; sending a signal to the user's supervisor or to security personnel; activating a security camera; and triggering an audible or visual alarm or alert.

Embodiments of the present invention operate on various platforms and under various information technology architectures, including a network, such as the Internet, and on various electronic devices. “Electronic device” and its derivatives refer to any machine that accepts input, processes it according to specified rules, and produces output. Electronic devices include: personal computers, workstations, laptop computers, mini-computers, mainframe computers, PDAs (Personal Digital Assistant), and fixed and programmable logic devices. Electronic devices can also include non-electronic components such as photonic or mechanical components.

In some embodiments of the invention an individual's behavior is regularly monitored after access has been granted until it has been determined that the user's behavior is within acceptable parameters. In other embodiments of the invention the individual's behavior is continuously monitored whenever they are logged on to the system. Alternatively, monitoring may take place only when there are sufficient resources available, such as sufficiently low traffic on the system or low utilization of CPU resources, that there will not be a noticeable slow-down is monitoring is conducted. In yet further embodiments monitoring can take place on a more-or-less random schedule.

By monitoring a user's behavior, even if that user fraudulently gained access to the system, the user will likely be flagged as an impostor shortly after accessing the system. The verification process does not require any concerted action by the user, such as entering a password, a human signature, voice sample, retinal scan, finger print, or DNA sample. To determine a user's validity multiple data values are evaluated, rather than a single datum such as a password/ID. Typically this process is unobtrusive to the user so as not to interfere with his/her normal operations on the system. Since the process does not require a prescribed sequence of actions by the user, the present invention is less subject to malware which captures keyboard or mouse events while a system is being used in an effort to capture a user's credentials for fraudulent purposes. The present invention provides an additional layer of protection which will contribute to the security and integrity of the system beyond an initial credential-based authentication scheme.

In all environments it is critical that users do not experience noticeable delays due to the use of monitoring software, particularly in an environment of moderate to high traffic volumes. Extended periods of inactivity due to slow connectivity result in fewer users visiting the provider's web site or a reduction in the capacity of on-line transactions on an e-commerce site. Even delays on a local system must be minimized so that the user's productivity is not adversely affected. Delays on the network can be due to slow connectivity as may be the case with a dial-up modem network connection. When in a networked environment, intra-page monitoring software captures the user's navigation on the client and transmits the data to a collecting server. The intra-page monitoring software's data transmission can add noticeable time to the dial-up client. A second source of delay on the user's machine can be due to slow or insufficient system resources. Such resources can include the central processing unit (CPU), random access memory (RAM), and network connection among others. Monitoring software requires some system resources to perform computations (encryption, compression, optimization, etc.) and store the collected data. On a system with slow or insufficient resources the additional resources consumed by the monitoring software might cause the user to experience a noticeable delay. Use of dynamic detection of resources and modification of parameters to reduce resource consumption tends to minimize delay. In some embodiments of the present invention if the software determines that delays are unavoidable for a particular client, it may disable the monitoring entirely. Likewise on a local electronic device; the present invention recognizes the relevant hardware and software configuration of the computer and adjusts the process to minimize any delays that may be experienced by the user.

FIG. 1. is a block diagram that depicts a typical client-server environment within which the present invention can function. In a client-server environment electronic devices are connected to one another, by “hard wiring” through cables and wires, or through wireless connections, forming a network. Some electronic devices connected to this network service requests made by other computers and are referred as servers, such as 10a and 10b. The servers run server software. The electronic devices that request the execution of tasks on the server or the transmission of information or objects from the servers are referred to as clients, such as 20a, 20b, and 20c. A client-server network can consist of any number of interconnected computers but in the case of the Internet, one embodiment of the present invention, there are millions of computers that are interconnected and can potentially communicate with one another. The networked computers communicate by sending data in a standard format, called a protocol. HTTP, 19, is a common protocol frequently used on the Internet.

The Company Server, 10a, represents the server or servers belonging to or used by an entity, usually a company, that is utilizing the present invention. In the most common setup the Company Server and the Collecting Server will each be on one or more machines. When there is a need for significant computation and storage resources, server farms with a plurality of machines, would represent the Company Server and the Collecting Server. On the opposite end of the scale it is physically possible to have the Company Server and the Collecting Server housed on one electronic device. The Company Server contains, among other things, the code, files and objects necessary to build customer's web pages. The client machines depicted in FIG. 1, may represent a plurality of machines or it is possible that more than one client function could be performed on a single electronic device.

When an individual using a client computer, depicted as Client, 20a, wishes to view the company's web page he/she will send a command to a Browser program, 41, that has been installed on the client machine. The command to download an instance of the web page onto the Client, 20a, is simply the web page address commonly called the URL or Uniform Resource Locator. Included in the web page code is a script, in the preferred embodiment JavaScript™ is the scripting language that is used, and an applet. The script is interpreted by the browser and one of the functions of the script is to call the applet for execution on the client machine. The script and applet have a number of functions when they run on the client machine, including: a) the capture and storage of attributes on the machine, 24, b) the compression, optimization and encryption of the stored data, c) the transmission of data, 25, from the client machine, 20a, to the Collecting Server, 10b, d) the monitoring of the client's machine's resources, e) modifying or stopping the capture of activity data if potential delays may occur on the client machine, f) monitoring when the client requests a new page or closes the Internet session, g) erasing the locally stored data after transmission. It should be noted that although the diagram depicts single servers and clients, in the usual environment there may be a plurality of client machines or electronic devices, as well as a plurality of server machines. A flow chart detailing the steps related to Company Server-Client-Collection Server functions is presented in FIG. 2A-F.

The Collecting Server, 10b, receives the temporarily locally stored attribute data from Clients (customers), 20a, and permanently stores the client attribute data from all clients in a file, 14. In the preferred embodiment the activity data is formatted and loaded onto a relational database to support an inquiry function. Client attribute data is captured and associated with each customer, the customer data for each session is analyzed, 15, to develop a suspicion level for each customer. When the data analyzer, 15, has an indication that selected customer attributes have exceeded the Suspicion Threshold, the signature engine, 16, creates a signature for the current session and compares this most recent signature of the customer with his/her established signature pattern. If aspects of the signature pattern suggest a different individual is using the same authentication an alert, 33, is transmitted to Client Web Security, 20c. In addition, additional authentication may be requested from the Client, 20a, or the Client may be prevented from accessing any other areas of the system. In addition to the above actions, the invention can transmit a message directly to the customer or take other customizable actions.

The individual or group that is responsible for administering the Customer Server can, from a Client Admin machine, 20b, perform a number of control functions to tailor or shut down the execution of the present invention.

FIG. 2A through FIG. 2F depicts the process of capturing a customer's web page attributes and verifying authorized access to resources. In all figures, the steps bounded by a shaded area titled, “Client (20a)” are executed on the Client, 20a. The Client represents the machine(s) used by a customer visiting the company web site. In all figures, the steps bounded by a shaded area titled, “Company Server (10a)” are executed on the Company Server, 10a. The Company Server is the server that handles requests for web site files requested by the Customer for a particular web site. In all figures, the steps bounded by a shaded area titled, “Collection Server (10b)” are executed on the Collection Server, 10b. The Collection Server receives all data that is collected on each Client and handles requests for customer signature verification.

In step 010, an individual on a client machine, termed Client, 20a, who is connected to the network, enters the address of the web page into a browser program that is resident on his/her machine. The address or pointer, termed a URL or Uniform Resource Locator, indicates the protocol to use, the path name and optionally the port number to which the TCP connection is made on the remote host machine. The address, http://www.CompanyServer.com, for example indicates that the HTTP protocol is being used to access the address www.CompanyServer.com on port number 80. Port number 80 being the default number for HTTP. Step 020, shows the connection to the Company Server having been made. In step 030, a client side HTML request is made to the Company Server, 10a, to initiate a server side script that checks if the Administrator has elected to turn off the process of recording customer attributes. The Administrator may wish to turn off the entire process, so no client has attributes recorded, for various reasons including isolating some other system problem or isolating a performance issue. The HTTP request is made without the need for refreshing or reloading the page.

Step 040, determines if the Administrator has requested that the recording of attributes be disabled. If the Administrator has not made the request, step 050, includes a JavaScript tag in the web page being viewed. If the Administrator has made the request, step 060, indicates that the web page will be returned unmodified. In step 070, on the Client machine, 20a, the web page is returned and in the following step, 080, the presence of the JavaScript tag will issue a connect to the Collecting Server, 10b, in step 090, while the absence of the JavaScript tag will allow the Client to use the present web page without any interaction from the present invention. In step 100, a JavaScript request is issued to the Collecting Server, 10b. In step 110, a check is made if the customer has a cookie present that had been established from a prior use of the present invention's software. If there is no cookie present, one is issued in step 120. The invention optionally provides for the web page customer to opt out of having his/her activity recorded. Step 130, tests to see if the option to decline the service was issued by the customer. If the service was not declined, step 140, returns the JavaScript and the applet code needed to capture the web page activity. If the service was declined a no-opt is passed in step 150.

The JavaScript response from step 140 or step 150 is received in step 160 on the Client (Customer) machine. In step 170, a test is made to determine if the capture code was received. If not the Client will use the present web page without any interaction from the present invention. In step 180, a connection is made to the Collecting Server, 10b, and step 190, a client side JavaScript HTTP request is made to the Collecting Server, 10b, for a Java applet. The Java applet, step 195 provides the logic for capturing and storing the activity data that occurs on the web page, as well as other detail about the Client's environment. The applet is received in step 200, and initiated in step 210.

A test is made in step 220, to check the resources on the client's machine, as well as the latency and bandwidth of the Client's network. If the applet determines that the resources limitations will cause unacceptable delays for the customer, depending on the limitation, the applet logic will adjust the compression and/or selection criteria or exclude the customer from the capture of data process. This is depicted in step 230. Step 240 determines if the customer is still navigating the web page. If not, all remaining captured data is transmitted to the Collecting Server, 10b, in step 250. If the customer is still navigating the web page, the data is collected in step 260. In step 270, a check is made, to determine if the amount of data captured has reached the threshold. If it has not, data continues to be captured in step 260 while the customer is navigating the page in step 240. If the quantity of data has exceeded the threshold, it is transmitted to the Collecting Server, 10b, in step 280. After the data has been sent to the Collecting Server, the process is repeated starting at step 240.

Steps 290 through 540, address the aggregation of data on the Collection Server, 10b, and after a representative amount of behavior data is collected on the individual customer, the customer's signature is created. A suspicion level developed from the client attributes associated with the current customer session is calculated and depending upon the threshold suspicion level, a determination is made whether or not to create a signature from behavior data of the customer's current session and compare the historic customer's signature with the customer's current signature. If the suspicion level is below the threshold or if historic and present signatures meet the criteria for similarity, the requested web page is returned to the customer. If neither of these conditions are met one or more of the following actions are taken: alerts are transmitted to responsible parties, the customer is notified of the possible unauthorized access and a web page requesting additional authentication is presented to the customer.

In step 290, the customer on the client, 20a, requests a web page from the Company Server, 10a, via the customer's browser program. The connection to the Company Server, 10a, is shown in step 300 and an HTTP request is made to the Company Server, 10a, as depicted in step 310. In step 320, on the Company Server, 10a, a connection is made to the Collection Server, 10b. A request is then made to the Collection Server, 10b, to formulate a Suspicion Level in step 330. In step 340, logic on the Collection Server, 10b, will determine if a signature has been established for the current customer. If a signature has not been established, the Collection Server, 10b returns an appropriate message to the Company Server, 10a. The Company Server, 10a responds appropriately to the Client, 20a, with an unmodified Web page as depicted in step 350. Step 360 shows the customer receiving the requested web page with the present invention's monitoring software.

If there is a signature present for the customer then in step 370, based upon the client attributes, the software on the Collection Server, 10b, formulates a Suspicion Level for the present customer session. In step 380, the Suspicion Level is compared to a suspicion threshold value. If the Suspicion Level does not exceed the threshold level, the Collection Server, 10b, responds to the Company Server, 10a, indicating that the customer's suspicion level is safe. The Company Server, 10a, in turn responds to the Client, 20a, with the requested Web page as depicted in step 390. Step 400 shows the customer receiving the requested web page with the present invention's monitoring software.

If the Suspicion Level exceeds the suspicion threshold level then the Signature Engine creates a signature for the customer's current session in step 410. A validation level for the signature compare is set in step 420. Next the customer's current session signature is compared to the historic signature for the customer in step 430 to determine if the difference between the two signatures exceeds the Validation Threshold. If it does not then the Collection Server, 10b, responds to the Company Server, 10a, indicating that the customer's suspicion level is safe. The Company Server, 10a, in turn responds to the Client, 20a, with the requested Web page as depicted in step 440. Step 450 shows the customer receiving the requested web page with the present invention's monitoring software.

If, in step 430, the difference between the customer's current session signature and the customer's historic signature exceeds the Validation Threshold value then, in step 460, the Collection Server, 10b, responds to the Company Server, 10a, indicating that the customer's suspicion level is irregular and should be treated as unsafe. Step 470 shows the Company Server, 10a, receiving the irregular signature status. The Company Server, 10a, in turn responds to the Client, 20a, to request additional credentials from the customer as depicted in step 480. Step 490 shows the customer receiving the request for additional authentication. Next the customer provides the necessary additional credentials to the Client, 20a, which sends them to the Company Server, 10a as depicted in step 500. The additional credentials are validated by the Company Server, 10a in step 510. If the additional credentials are valid, the Company Server, 10a will respond to the Client, 20a, with the requested Web page. Step 520 shows the customer receiving the requested web page with the present invention's monitoring software.

If, in step 510, the additional authentication is not valid, then the user is declared to be an impostor. The Company Server, 10a, in turn will notify the appropriate personnel within the company and/or the customer whose account is being used as depicted in step 530. The Company Server, 10a, will then deny the user access to the resource as depicted in step 540.

Steps 810 through 840 in FIG. 2F depict the Web site Administrator's ability to turn on or turn off the present invention so that no monitoring or tracking is done on any of the clients who request a Web page from that particular Web site. Step 810 depicts the Administrator, 20b, requesting access to the Collecting Server, 10b. If a request is received from the Administrator, step 820 determines if the request is to disable service. If it is service is disabled as depicted in step 840, otherwise the JavaScript tag is enabled in step 830 and the present invention is active.

A stand alone step 900 is shown in FIG. 2F and depicts the creation or refining of the customer signature. This separate step indicates that the signature creation process may not be performed as part of the regular flow but can be done asynchronously as a parallel task to the rest of the process. Customer behavior data from each customer session is used to either create a signature or refine an existing customer signature. The creation of the signature is only done as part of the regular flow when step 410 (FIG. 2D) is initiated.

While this invention has been particularly shown and described with references to preferred embodiments thereof, it will be understood by those skilled in the art that various changes in form and details may be made therein without departing from the spirit and scope of the invention as defined by the appended claims. Those skilled in the art will recognize or be able to ascertain using no more than routine experimentation, many equivalents to the specific embodiments of the invention described specifically herein. Such equivalents are intended to be encompassed in the scope of the claims.

1) A method comprising:
(A) capturing at least one set of behaviors of a first user;
(B) generating a first signature from the first user's set(s) of behaviors;
(C) capturing at least one set of behaviors of a second user;
(D) generating a second signature from the second user's set(s) of behaviors; and
(E) calculating the difference between the two signatures, wherein the first user and the second user are purportedly the same user.

2) The method of claim 1 comprising estimating the probability that the first user and the second user are the same person.

3) The method of claim 1, operating in a networked system to detect usage of the system by an unauthorized individual, said method comprises:
(A) operating at least one client-side script, wherein the script detects users' behavior data that are executed on the client, and transmits the behavior data to a collecting server;
(B) storing the behavior data transmitted by the client on a collecting server;
(C) determining if the differences between the first signature and the second signature suggest that the first user and the second user are not the same person.

4) The method of claim 1 comprising:
(A) establishing a validation threshold; and
(B) comparing the difference between the two signatures to the validation threshold.

5) The method of claim 4 wherein
the validation threshold is a maximum acceptable difference between the two signatures from the purported same user; and wherein
if the difference between the two signatures is greater than the validation threshold; the method comprises
declaring a possible security breach.

6) The method of claim 4 wherein
the validation threshold is a minimum acceptable difference between the two signatures from the purported same user; wherein
if the difference between the two signatures is less than the validation threshold; the method comprises
declaring a possible security breach.

7) A method comprising:
(A) capturing a first subset of attributes of a first user in a first session;
(B) capturing a second subset of attributes of a second user in a second session;
(C) associating each subset of attributes with each user and the appropriate session;
(D) establishing a suspicion threshold; and
(E) comparing the difference between the first and the second subsets of attributes to the suspicion threshold.

8) The method of claim 7 wherein both the first and second subsets of attributes consist of behaviors.

9) A method to detect usage of a system that executes on an electronic device by an unauthorized individual, said method comprises:
(A) in a first user session, capturing and storing at least one of a first user's attributes as a first set of data, and associating the data with the first user;
(B) generating and storing a first signature based on at least the first set of data;
(C) in a second user session, capturing and storing at least one of a second user's attributes as a second set of data, and associating the data with the second user;
(D) generating and storing a second signature based on at least the second set of data;
(E) calculating the differences between the first signature and the second signature;
(F) determining if the differences between the first signature and the second signature suggest that the first user and the second user are not the same person.

10) The method of claim 9 comprising establishing a validation threshold; and if the differences between the first signature and the second signature exceed the validation threshold, declaring a possible security breach.

11) The method of claim 9 comprising establishing a validation threshold; and if the validation threshold exceeds the differences between the first signature and the second signature, declaring a possible security breach.

12) The method of claim 9 wherein determining if the differences between the first signature and the second signature suggest that the first user and the second user are not the same person comprises:
(A) establishing an independent relative weight to each attribute;
(B) calculating the magnitude of the differences between the first signature and the second signature;
(C) biasing the magnitude of the differences based on the relative weight of each attribute; and
(D) if the magnitude of the differences exceeds the signature threshold level; and
declaring a possible security breach.

13) The method of claim 9 comprising:
(A) the first user defining an alert mechanism; and if differences between the first signature and the second signature suggest that the first user and the second user are different persons,
(B) initiating the alert mechanism.

14) The method of claim 9 operating on a local electronic device.

15) The method of claim 9 operating in a network environment.
